(19) United States
(12) Patent Application Publication
(10) Pub. No.: US 2008/0193600 A1
(43) Pub. Date: Aug. 14, 2008

(54) FOOD PRODUCTS CONTAINING TUBER AND LEGUME PRODUCTS AND PROCESSES FOR PRODUCING THE SAME

(75) Inventors: Charles E. Werstak, Normal, IL (US); Kati R. Ledbetter, Mt. Zion, IL (US); Thomas P. Binder, Decatur, IL (US)

Correspondence Address: KIRKPATRICK & LOCKHART PRESTON GATES ELLIS LLP;HENRY W. OLIVER BUILDING, 535 SMITHFIELD STREET, PITTSBURGH, PA, 15222, US

(73) Assignee: Archer-Danieis-Midland Company, Decatur, IL (US)

(21) Appl. No.: 12/028,661

(22) Filed: Feb. 8, 2008

Related U.S. Application Data
(60) Provisional application No. 60/900,681, filed on Feb. 9, 2007.

(51) Int. Cl. A23L 1/20; A23L 1/30; A23L 1/216

(52) U.S. Cl. 426/72; 426/634; 426/564; 426/637; 426/74

(57) ABSTRACT

Edible compositions comprising legume products and tuber products are disclosed. In certain examples, the compositions can comprise bean powder combined with instant mashed potatoes. Such compositions can have excellent taste and improved nutrition. Methods of manufacture and preparation of the legume and tuber products are also disclosed.

### CROSS-REFERENCE TO RELATED APPLICATIONS

This application claims the benefit of U.S. Provisional Application No. 60/900,681, filed Feb. 9, 2007.

### TECHNICAL FIELD

The present invention relates generally to food technology and, more particularly, to food products containing tuber and legume compositions and their related processes.

### BACKGROUND

Tubers, such as potatoes, play a large role in the diet of many Americans. For example, products consisting of potato powders or flakes offer a convenient approach for providing “instant” potatoes. Such products are typically mixed with water and/or milk and heated to produce a product having the consistency and taste of mashed potatoes. Mashed potato or puréed potato is commonly made in many western countries, including, for example, Germany, Ireland, the United Kingdom, and the United States. Although it can be made from any tuber, it is usually made by mashing peeled or unpeeled boiled potatoes, mixing the potatoes with heated milk or cream and then flavoring according to taste. In France, an egg yolk is added to mashed potatoes to make Pommes duchesse. Potatoes, however, are high in starch and sugars and lack essential nutrients, such as dietary fiber, protein, calcium, and iron. Such recipes as edamame potatoes, which contain a green soybean mash, can improve the nutritional quality of mashed potatoes, but lack the convenience of a highly nutritional food product that can be rapidly prepared.

In the United States, there is increasing concern over the consumption of high sugar and high fat foods by the population. In fact, in 2005, the U.S. Government revised the Dietary Guidelines for food consumption (USDA, Dietary Guidelines for Americans (2005)). One of the goals of the revision of the Dietary Guidelines is to reduce the incidence of obesity among the youth in the United States, as too many children are overweight due to a lack of exercise and poor eating habits.

In the 2005 Dietary Guidelines Pyramid, beans and peas are listed under both the “Vegetables” and the “Meats and Beans” categories, thus, emphasizing the healthy nature of legumes in the diet. Id. Beans are also known to have a low glycemic index and are digested slowly, thus helping to further reduce the risk of obesity.

In addition to the emphasis on lower fat and lower sugar diets, beneficial effects of legumes are becoming increasingly apparent. For instance, inositol polyphosphates, which are naturally occurring substances found in most legumes, have been implicated in being able to inhibit the growth of cancer. See, Cancer Resources, 2005; 65 (18), (Sep. 15, 2005). Thus, the benefits of healthy diets including legumes are gaining recognition in the United States. For example, Kon teaches in U.S. Pat. No. 4,084,016 that mixtures of legume powder necessarily comprising acidified soybean seed powder can be used to make healthier snack chips.

With increased efforts being made to provide populations with healthier food and snack options, as well as an increased awareness of the health benefits of legumes, there exists a need for healthier food products and foodstuffs that provide the beneficial nutritional effects of legumes. As such, there is a continuing need to provide food products containing the healthy effects of leguminous products in a form that is more attractive to consumers.

### SUMMARY

In each of its various embodiments, the present disclosure helps fulfill the need for nutritious food products that may be also be convenient and efficient to prepare.

In one embodiment, a composition is provided that comprises a tuber product such as dehydrated tubers and a dehydrated legume product.

In another embodiment, a method of increasing protein, fiber, or protein and fiber consumption in a population is disclosed. The method comprises providing the population with the opportunity to consume a composition comprising dehydrated tubers and a dehydrated legume product.

In a further embodiment, a process is disclosed in which a mixture is formed by combining dehydrated potatoes with a legume product having an enhanced amount of fiber as compared to a raw legume from which the legume product originates.

In another embodiment, a system comprising a first composition comprising dehydrated tubers and a second composition comprising dehydrated legumes is presented.

In an additional embodiment, a food composition is disclosed. In certain embodiments, the food composition comprises a potato product, an edible bean product, and a liquid. The potato product, the edible bean product, and the liquid are present in the food composition in such amounts as to give the food composition a consistency of a mashed potato product. In yet other embodiments, the presence of liquid is optional and may comprise, when present, cooking oil for example. In such embodiments, examples of food compositions include French fries, tater tots, hash browns, and potato formed patties, inter alia.

In another embodiment, a food composition comprising instant mashed potatoes in combination with bean powder is presented. Such products are especially beneficial to institutional populations, such as, for example, school children, hospital patients, nursing home patients, and inmates. These populations in particular are likely to benefit from the efficient addition of fiber and protein provided by tuber-containing foods having leguminous products.

It should be understood that this invention is not limited to the embodiments disclosed in this Summary, and it is intended to cover modifications that are within the spirit and scope of the invention, as defined by the claims.

### DETAILED DESCRIPTION

Other than in the operating examples, or unless otherwise expressly specified, all of the numerical ranges, amounts, values and percentages, such as those denoting amounts of materials, times and temperatures of reaction, ratios of amounts, and others in the following portion of the specification, may be read as if prefaced by the word “about,” even though the term “about” may not expressly appear with the value, amount or range. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

Notwithstanding the fact that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10. In addition, the terms “one,” “a,” or “an” as used herein are intended to include “at least one” or “one or more,” unless otherwise indicated.

In certain embodiments, the present disclosure provides a composition comprising dehydrated tubers and a dehydrated legume product. As used herein, the term(s) “dehydrated,” “dry,” “dried,” and the like, are used interchangeably and refer to products having a moisture content of no more than 20%, 15%, 10% or less, by weight. See, for example, Table 1 where some dehydrated bean products comprise 7.5% moisture and others comprise 9.5% moisture.

TABLE 1
DEHYDRATED BEAN PRODUCTS

| | MAXIMUM | | DIETARY | | | |
|---|---|---|---|---|---|---|
| PRODUCT | MOISTURE % | PROTEIN % | FIBER % | MAX. FAT % | CARBOHYDRATES % | APPLICATIONS |
| Refried Pinto Beans | 7.5 | 20 | 21 | 10 ± 1.5 | 58 | Five-minute product; dry |
| Refried Black Beans | 7.5 | 20 | 21 | 10 ± 1.5 | 58 | package for food service |
| | | | | | | and retail; ideal for bean |
| | | | | | | dips, tacos and burritos, |
| | | | | | | nachos, soup bases, taco |
| | | | | | | salads, and side dishes |
| Homestyle Refried Pinto | 7.5 | 20 | 21 | 10 ± 1.5 | 58 | Twenty-five-minute product; |
| (includes whole beans) | | | | | | dry package for food service |
| | | | | | | and retail; ideal for soups, |
| | | | | | | salads, and side dishes |
| Whole Pinto Beans | 9.5 | 21 | 27 | 1.5 | 68 | Twenty-minute product; dry |
| Whole Small Red Beans | 9.5 | 24 | 23 | 1.0 | 64 | package for food service |
| Whole Black Beans | 9.5 | 21 | 29 | 1.0 | 69 | and retail; ideal for soups, |
| Whole Navy Beans | 9.5 | 21 | 23 | 1.0 | 62 | salads, and side dishes |
| Whole Dark Red Kidney Beans | 9.5 | 23 | 24 | 0.5 | 62 | |
| Whole Light Red Kidney Beans | 9.5 | 23 | 24 | 0.5 | 62 | |

Tubers encompassed in the present disclosure may be any tuber known or disclosed herein. As used herein, the term “tuber” encompasses a short fleshy plant usually having an underground stem bearing minute scale leaves, each of which bears a bud in its axil and is potentially able to produce a new plant. Suitable tuber varieties that may be used include: apio (i.e., arracacha); arrowhead (i.e., arrowroot or Chinese potato or goo or seegoo or Chinese arrowhead or tse goo or ci gu or tsu goo); cassava (i.e., manioc or mandioca or tapioca root or yucca or yucca root or yuca root or bitter cassava or Brazilian arrowroot); Chinese artichoke (i.e., crosne or Japanese artichoke or chorogi); water chestnut (i.e., Chinese water chestnut); Japanese artichoke; Jerusalem artichoke (i.e., sunchoke or sunroot or topinambour or girasole); jicama (i.e., jícama or yam bean or Mexican yam bean or ahipa or ahipal or saa got or Mexican potato or Chinese turnip); lily root; ling gaw; malanga (i.e., tanier or tannier or tannia or yautia); potatoes; sweet potatoes (i.e., yams); taro (i.e., taro root or dasheen or coco or cocoyam or eddo or Japanese potato or baddo or elephant's ear or old cocoyam or sato-imo); and others.

Suitable potato tubers include, for example, sweet, russet, Yellow Finn, new, red-skinned, white round, white rose, long white, purple, blue, Yukon gold, Caribe, fingerling, Bintje, oca, and combinations of any thereof. A tuber product may be formed from the tubers disclosed herein or known in the art. The term “tuber product” encompasses any manufactured item comprising tubers, including potato products. For example, a tuber product may, but need not, comprise dehydrated tubers. In certain embodiments, the tuber product may be dehydrated and include, for example, dehydrated potato flakes, dehydrated potato powder, dehydrated yam flakes, dehydrated yam powder or any combination thereof. For example, in certain embodiments, the dehydrated tuber can form mashed potatoes when rehydrated.

The tuber product may be present in the composition in any desirable amount, such as, for example, in amounts ranging from 1% to 99% dry weight of the composition, and in certain other embodiments present in amounts ranging from 25% to 50% dry weight, 50% to 75% dry weight, and 25% to 75% weight. In yet other embodiments, the legume product may be present at amounts of up to 25%, up to 50%, up to 75% or higher dry weight. In some embodiments, the tuber product can be blended or mixed with another product at a ratio of 25:75, 50:50, and 75:25, respectively, on the basis of dry weight, for example.

The compositions of the present disclosure also comprise legumes. Legumes disclosed herein may be used to form a “legume product,” which refers to any manufactured product comprising legumes. The term “legume” as used herein, refers to various dehiscent fruit derived from a single simple pistil and include, for example, alfalfa, beans, clovers, kudzu, lespedeza, locust, peas, peanuts, soybeans, vetch, and others. Legumes include pulses which are the seed of such species such as Phaseolus. For example, peas (Pisum spp.), cowpeas (Vigna spp.) such as black-eyed peas, and lentils (e.g., Lens vulgaris), may be processed into a legume product as disclosed in some embodiments. Other legume genii and varieties are also useful. For example, Cicera arietenum (chickpeas), Glycine max (soybeans), Arachis hypogaea (peanuts) and trefoil (Lotus comiculatus) may be used in the methods described herein. Bean varieties that may be used include shell beans, snap beans, string beans, pinto beans, Great Northern beans, navy beans, red beans, black beans, dark and light red kidney beans, fava beans, green baby lima beans, pink beans, myasi beans, black-eyed beans, garbanzo beans, cranberry beans, white beans, rice beans, adzuki bean, black-eyed peas, cannelini beans, broad beans, Flageolet beans, mung beans, Soissons beans, Mayocoba beans, butter beans and others. The many varieties known in the art and disclosed herein may be used to form a legume product, including edible bean products. The legume product may, but need not, be dehydrated. In certain embodiments of the present disclosure, the legume product may be dehydrated and may include, for example, legume flakes, legume powder, whole legumes, legume pieces and any combination of at least two thereof. The legume product may also be blanched, cooked, tempered, dehydrated, and combinations of any thereof. In certain examples, the legume product is a bean powder. Where a legume product is suitable to be served or sold for human or animal consumption under regulatory approval, the legume product is referred to herein as an “edible legume product” and includes “edible bean products.”

In some embodiments, the legume product may be present in a composition in any desirable amount, such as, for example, in amounts ranging from 1% to 99% dry weight of the composition and, in certain other embodiments, present in amounts ranging from 25 to 50% dry weight, 50 to 75% dry weight, and 25 to 75% dry weight. In yet other embodiments, the legume product may be present at amounts of up to 25%, up to 50%, up to 75% or higher dry weight. In some embodiments, the legume product can be blended or mixed with another product at a ratio of 25:75, 50:50, and 75:25, respectively, on the basis of dry weight, for example.

In certain embodiments, the tuber product can form mashed potatoes when rehydrated. In yet other embodiments, the tuber product may be combined with the legume product in any desirable amount, such as, for example, amounts ranging from 1% to 99% by dry weight of the composition. In certain examples, bean powder can be added to potato flakes to form instant mashed potatoes comprising legume product upon rehydration. For example, 25-99% dry weight of the bean powder can be added to potato flakes. In certain other embodiments, a dry combination of tuber product and legume product may comprise 25% dry weight potato product and 75% dry weight legume product. When such a dry combination is rehydrated and cooked with other ingredients to form mashed potatoes, the finished product may comprise 3% to 12% by weight of the legume product. For example, mashed potatoes may comprise 4% of the cooked product and beans 12% of the finished product. Thus, in some embodiments, the legume product and/or the tuber product may be present at a range of 3% to 99% by dry weight of the final product.

In certain other embodiments, the legume product can be added to potato products such as French fries, tater tots, hash browns, potato formed patties, and any other example of a potato product. In such embodiments, legume product can be added at any stage or potato processing. In certain examples, a food composition comprising potato and legume products can be cooked in oil, such as vegetable oil, thereby preserving the original favor of the product while increasing the amount of dietary fiber in the product.

In certain embodiments, a composition may comprise dehydrated legume particles, such as ground, powdered, milled, pulverized, flaked, and comminuted dehydrated tubers; ground, powdered, milled, pulverized, flaked, and comminuted dehydrated legume products; and combinations of any thereof. For example, certain bean powders meet specifications such as 95% of the powder passing through an 80 mesh sieve. In certain other embodiments, the size of the particles meet such specifications as 90% of the particles being less than 10 microns. In some embodiments, even finer particles sizes are contemplated. In certain other embodiments, the powder may comprise soy isolates which average 325 mesh with 90% of the particle being less than 10 microns. In yet other embodiments, the powder may comprise soy flour in which 90% of the particles pass through 100 mesh. In some embodiments, the particles may pass through a range of 100-600 mesh. In yet other embodiments, the particle size may range from 1,000 microns to 10 microns. In certain other embodiments, at least 75%, 80%, 85%, 90%, 95% or greater of the particles can pass through a mesh sieve of the various sizes described herein.

Generally, powders, granules and pieces may be classified according to the particle size distribution as shown in Table 2.

TABLE 2

| Description Term | Mesh Opening Size (microns) | Mesh Size Number |
|---|---|---|
| Whole Beans and | >2000-4760 | >10-4 |
| Flakes | | |
| Pieces | 500-2000 | 35-10 |
| Granules | 355-500 | 45-35 |
| Coarse | 177-355 | 80-45 |
| Moderately Coarse | 125-177 | 120-80 |
| Fine | 74-125 | 200-120 |
| Very Fine | 10-74 | 1250-200 |

A legume powder or product may be produced by processing a dehydrated legume or legume product. In another embodiment, a dehydrated legume product may be used to form the legume powder, and be produced by milling a dehydrated legume or the dehydrated legume product into a powder. In another embodiment, a dehydrated legume or legume product is subjected to a milling process to produce a dehydrated legume powder. In a further embodiment, the dehydrated legume or legume product is subjected to a form of crushing or pulverizing such as passage of the dehydrated legume or legume product through a hammermill or universal mill. In one embodiment, the dehydrated legume or legume product is ground in a PC-20 mill. The ground or powdered dehydrated legume or legume product may be passed through a Swecoscreen 60 mesh, wherein the ground or powdered dehydrated legume or legume product has a particle size of less than about 0.25 mm. In another embodiment, the ground or powdered dehydrated legume product are produced such that about 95% of the ground or powdered dehydrated legume product passes through an 80 mesh screen. The ground or powdered dehydrated legume or legume product may further be passed near a magnet to remove any metallic (i.e., iron-containing) contaminants, and further be placed in containers for shipping or placed in a food product.

In one embodiment, the dehydrated legume or dehydrated legume product suitable for milling is produced using the process described in U.S. Patent Application 2005/0095346 assigned to Archer-Daniels-Midland Company of Decatur, Ill., entitled Process for the Production of Reconstitutable Bean Products, published May 5, 2005, the contents of the entirety of which is incorporated by this reference. In another embodiment, the process for dehydrating the legume or legume product may include blanching the legume or legume product, cooking the blanched legume or legume product, and/or dehydrating the cooked legume or legume product to form a dehydrated or reconstitutable legume or legume product. In a further embodiment, water may be used to blanch and/or cook the legumes or legume products, and an organic acid may optionally be added to the blanching water, the cooking water, or both.

In other embodiments, the process for producing the dehydrated legume or dehydrated legume products includes conditioning the legumes or legume products by subjecting the legumes or legume products to hydration; cooking the legumes or legume products; depressurizing the cooked legumes or legume products; and/or dehydrating the legumes or legume products to form a reconstitutable legume or legume product. In other embodiments, the process for dehydrating the legume or legume product may also include use of an organic acid in the hydration, blanching, and/or cooking step, and the process may further include washing and/or destoning raw legumes used in the process.

In a further embodiment, a dehydrated legume, a dehydrated legume flour, a dehydrated legume powder or a dehydrated legume product used in the foodstuffs of the present invention may have an increased dietary fiber percentage on a dry weight basis as compared to a non-dehydrated or raw legume, flour, powder or product. For example, dehydrated pinto beans comprise about 27% dietary fiber, while non-dehydrated or raw pinto beans comprise about 12% dietary fiber; dehydrated small red beans comprise about 23% dietary fiber, while non-dehydrated or raw small red beans comprise about 8.9% dietary fiber; dehydrated black beans comprise about 29% dietary fiber, while non-dehydrated or raw black beans comprise about 13.3% dietary fiber; dehydrated navy beans comprise about 23% dietary fiber, while non-dehydrated or raw navy beans comprise about 9.8% dietary fiber; dehydrated dark red kidney beans comprise about 24% dietary fiber, while non-dehydrated or raw light red kidney beans comprise about 10.6% dietary fiber; and dehydrated dark red kidney beans comprise about 24% dietary fiber, while non-dehydrated or raw light red kidney beans comprise about 10.6% dietary fiber. It will be apparent by those of ordinary skill in the art that the amounts and percentages of dietary fiber in a legume or legume product may vary depending on various factors and that the amounts of fiber disclosed herein are exemplary in nature.

In one embodiment, a food product or ingredient for use in a foodstuff comprises a dehydrated legume powder and another ingredient, such as, for example, potatoes. In other embodiments, various ingredients may be added to the foodstuff in combination with the dehydrated legume powder or the dehydrated legume flour, as well as other ingredients, such as flour or meal. Examples of such various ingredients include, but are not limited to, proteins such as wheat protein, wheat protein isolate, wheat gluten, buttermilk solids, whey protein, whey protein isolate, milk powders, egg protein, canola protein, pea protein, wheat protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates and mixtures of any thereof. Other ingredients that may be added to the foodstuff include, but are not limited to, texture modifiers, such as, for example, calcium carbonate.

In other embodiments, a pre-cooked or dehydrated legume product having utility in the embodiments of the present invention may include, without limitation, a sugar and/or calcium chloride. Non-limiting examples of such legume products are disclosed in Table 3. Other legume products that may be used in the embodiments of the present invention are disclosed in Table 4. The legume products of Tables 3 and 4 are commercially available from Archer-Daniels-Midland Company of Decatur, Ill.

TABLE 3
Nutritional analysis of bean powders

| | Pinto Bean | Black Bean | Small Red | Navy Bean | Great Northern |
|---|---|---|---|---|---|
| Per 100 grams | Powder | Powder | Bean Powder | Powder | Bean Powder |
| Calories | 299 | 311 | 304 | 305 | 319 |
| Calories from fat | 20 | 20 | 17 | 23 | 20 |
| Calories from Saturated fat | 5 | 4 | 4 | 5 | 4 |
| Fatty Acid Profile | | | | | |
| Total Fat (g) | 2.27 | 2.27 | 1.88 | 2.55 | 2.27 |
| Saturated Fat (g) | 0.5 | 0.48 | 0.43 | 0.52 | 0.49 |
| Monosaturated Fat (g) | 0.26 | 0.32 | 0.14 | 0.34 | 0.26 |
| Cis/cis polyunsaturated fat (g) | 1.41 | 1.37 | 1.23 | 1.58 | 1.42 |
| Trans Fat (g) | 0 | 0 | 0 | 0 | 0 |
| Carbohydrate, Total (g) | 65 | 66.4 | 68.4 | 64.1 | 64 |
| Carbohydrate, Available (g) | 46.6 | 50.3 | 51.0 | 46.2 | 50.1 |
| Total Dietary Fiber (g) | 24.7 | 22.2 | 24.0 | 26.4 | 19.9 |
| Insoluble fiber | 18.4 | 16.1 | 17.4 | 17.9 | 13.9 |
| Soluble fiber | 6.3 | 6.1 | 6.6 | 8.5 | 6.0 |
| Sugars (HPLC), in (g) | | | | | |
| Fructose | 0 | 0 | 0 | 0 | 0 |
| Glucose | 0 | 0 | 0 | 0 | 0 |
| Sucrose | 3.84 | 3.64 | 2.39 | 4.02 | 3.66 |
| Maltose | 0 | 0 | 0 | 0 | 0 |
| Lactose | 0 | 0 | 0 | 0 | 0 |
| Raffinose | 0.21 | 0.26 | 0.35 | 0.33 | 0.25 |
| Stachyose | 2.28 | 2.00 | 2.91 | 2.53 | 2.08 |
| Protein (g) | 23.1 | 22.4 | 20.8 | 24.4 | 24.6 |
| Vit A Retinol (IU) (less than) | 100 | 100 | 100 | 100 | 100 |
| Vit C Total (mg) | 2.56 | 3.1 | 2.98 | 3.16 | 3.04 |
| Vit E (IU) (less than) | 0.1 | 0.1 | 0.1 | 0.1 | 0.1 |
| Vit B1 (Thiamin) (mg) | 0.2 | 0.4 | 0.31 | 0.27 | 0.19 |
| Minerals and Metals | | | | | |
| Sodium (mg) | 37.2 | 43.6 | 29.0 | 27.1 | 30.7 |
| Potassium (mg) | 919 | 927 | 1080 | 1000 | 750 |
| Calcium (mg) | 197 | 292 | 188 | 259 | 310 |
| Magnesium (mg) | 130 | 121 | 103 | 126 | 125 |
| Phosphorus (mg) | 403 | 440 | 417 | 520 | 481 |
| Folic Acid, Total (μg) | 76.4 | 107 | 132 | 132 | 127 |
| Zinc (mg) | 2.66 | 2.52 | 2.37 | 2.01 | 2.27 |
| Iron (mg) | 5.17 | 5.45 | 5.87 | 5.15 | 5.22 |
| Copper (mg) | 0.715 | 0.773 | 0.628 | 0.936 | 0.625 |
| Niacin (mg) | 1.02 | 1.52 | 1.39 | 1.49 | 1.51 |
| Moisture (%) | 6.91 | 5.99 | 5.98 | 5.79 | 6.43 |
| Ash (%) | 2.766 | 2.959 | 2.950 | 3.160 | 2.745 |
| Cholesterol (mg) | 0 | 0 | 0 | 0 | 0 |

TABLE 4
Properties of bean products.

| Bean | Moisture | | Dietary | | Carbohydrates | Calories |
|---|---|---|---|---|---|---|
| Type | (%) Max | Protein (%) | Fiber (%) | Fat (%) | (%) | per 100 grams |
| Pinto Bean powder | 9.5 | 22.3 | 23.0 | 1.8 | 63.1 | 292 |
| Black Bean powder | 9.5 | 24.6 | 22.2 | 2.0 | 65.6 | 321 |
| Small Red Bean powder | 9.5 | 23.6 | 22.5 | 1.8 | 67.2 | 323 |
| Navy Bean powder | 9.5 | 22.3 | 27.7 | 2.0 | 64.8 | 367 |
| Great Northern Bean powder | 9.5 | 23.0 | 22.3 | 2.2 | 67.4 | 325 |
| Dark Red Kidney Bean pieces | 9.5 | 23.3 | 23.8 | 1.6 | 62.1 | 356 |
| Light Red Kidney Bean pieces | 9.5 | 23.3 | 23.8 | 1.6 | 62.1 | 356 |
| White Kidney Bean pieces | 9.5 | 25.3 | 23.8 | 1.8 | 61.7 | 298 |
| Pink Bean pieces | 9.5 | 21.0 | 12.7 | 1.1 | 64.2 | 343 |
| Mayocoba Bean pieces | 9.5 | 26.5 | 19.8 | 1.9 | 62.9 | 320 |

Both batch and continuous processes can be used to manufacture dehydrated legume products. For example, the process disclosed in U.S. Pat. No. 4,676,990 produces a mash of legume material and forms the mash into shapes. The process disclosed in U.S. Pat. No. 5,863,592 uses a specific number of rollers to flake the legume product. U.S. Pat. Nos. 5,902,629 and 5,213,831 disclose pre-cooking beans using infrared energy. U.S. Pat. No. 5,916,624 is drawn to methods of flash freezing legume products. A milling step is performed in the process disclosed in U.S. Pat. No. 5,980,971. Prior to processing, whole beans can be cracked in the process of WO 98/15190. Additionally, legumes can be processed according to the methods disclosed in U.S. Patent Application Publication No. 20060153965, which is incorporated by reference in its entirety herein. In yet other embodiments, non-acidified bean powder can be used, while in other embodiments the powder is acidified or comprises a mixture of acidified and non-acidified bean powder.

In certain embodiments, one or both of the dehydrated tubers and legume product may initially be in flake and/or powdered form, and may be further processed, as provided herein. For example, one or both of the dehydrated tubers and legume products may be in the form of dried powder flakes. In certain embodiments, the composition comprises 75% dehydrated potato flakes or potato powder and 25% dehydrated legume flakes or dehydrated legume powder. In other embodiments, the composition comprises 50% dehydrated potato flakes or potato powder and 50% dehydrated legume flakes or dehydrated legume powder. In certain embodiments, the composition comprises 25% dehydrated potato flakes or potato powder and 75% dehydrated legume flakes or dehydrated legume powder. Compositions comprising the combination of dehydrated tubers and dehydrated legumes are particularly convenient to process, and may be efficiently prepared on a large scale.

Those of ordinary skill in the art recognize that a person may prepare the compositions as disclosed herein in any manner that may be suitable for serving. For example, while one person may whip a composition by mechanical means, another may use utensils to slightly mash the composition to the consistency of their liking. In certain embodiments, a composition comprising dehydrated legumes and dehydrated tubers can have a texture which is consistent with what is commonly found in commercial and home-prepared potatoes and beans to which various methods of processing, such as chopping, whipping and pureeing, as well as other food processing techniques are applied. At a blend of 25% beans and 75% potatoes prepared with milk, a texture consistent of that of commercially prepared mashed potatoes can be achieved.

Nutritionally enhanced mashed tubers, such as potatoes, may be formed by rehydrating the composition comprising dehydrated tubers and dehydrated legumes. Rehydration is accomplished by mixing the composition of dehydrated tubers and dehydrated legume product with a liquid such that the consistency of the composition is similar to that of conventional mashed potatoes. The liquid may be any suitable rehydration liquid, such as, for example, water, milk, cream, or any combination thereof. The liquid may be added to the mixture of dehydrated tubers and dehydrated legume products such that the mixture has a texture and consistency of a food product such as mashed potatoes.

In certain embodiments of the present disclosure, the nutritional value of the composition may be further enhanced by the addition of a nutritional supplement. The nutritional supplement may be a calcium-containing compound, folic acid or a salt thereof, a vitamin, a mineral or any combination thereof. In certain embodiments, the flavoring of the composition may be enhanced through the addition of certain additives, such as a salt; a flavoring agent; such as a spice or a seasoning; butter; margarine; and the like. It is also contemplated that the composition of the present disclosure may include other components that may be applied thereto. For example, in certain embodiments, the composition may include other ingredients, such as food colorants, edible oils or fats, emulsifiers, leavening agents, natural or artificial sweeteners, starches, thickening agents, a fiber such as a soluble fiber (e.g., inulin, FIBERSOL™, etc.) or an insoluble fiber, a cellulose (e.g., microcrystalline cellulose or carboxymethylcellulose), potato starch, corn starch, wheat starch, tapioca starch, a vegetable product, a fruit product, a nut product, or combinations of any thereof.

The food product of the present disclosure may be an excellent source of dietary fiber. In one embodiment, for example, twenty-three grams of the composition of dehydrated tubers and dehydrated legumes provides at least one gram of dietary fiber. In another embodiment, two hundred ten grams of the composition provide at least one gram of dietary fiber. In a further embodiment, twenty-three grams of the composition of dehydrated tubers and dehydrated legumes provide at least two grams of dietary fiber. In another embodiment, two hundred ten grams of the mixture provide at least two grams of dietary fiber.

The present disclosure also provides a method of increasing the protein, fiber, or protein and fiber consumption of a population by providing that population with the food products as set forth herein. The population may be selected based on the institution which serves them food; for example, the population may comprise schoolchildren, inmates, hospital patients, soldiers, nursing home patients, or combinations of any thereof.

The compositions of the present disclosure may be formed by various processes that create a mixture, such as by combining dehydrated tuber products, such as potatoes, with a legume product having an enhanced amount of fiber as compared to a raw legume from which the legume product originates. In certain embodiments, the legume product may be blanched, cooked, and/or dehydrated. The mixture may be cooked. In this regard, the tuber product and the legume product may be processed, such as cooked, separately and then combined, mixed together prior to cooking, or simultaneously mixed and cooked, such as in a batch process. In one embodiment, a vitamin, a mineral, or a combination of the two may be added. In certain embodiments, the mineral added is a calcium salt. Milk, water, or a combination thereof may be added to the mixture to form mashed potatoes. In a further embodiment, the mixture may be formed into a shape.

In some embodiments, a system comprising a first composition comprising dehydrated tubers and a second composition comprising dehydrated legumes is disclosed. In one embodiment, the first system is stored in a first container and the second system is stored in a second container. The system may include indicia for directing a user on how to incorporate the first composition and the second composition into a food product. In one embodiment of the system, the dehydrated tubers may take the form of dehydrated potato flakes, dehydrated potato powder, dehydrated yam flakes, dehydrated yam powder, or any combination thereof. In this embodiment, upon rehydration and cooking of the dehydrated potato flakes or potato powder, mashed potatoes are formed.

In a further embodiment, the present disclosure provides a food composition comprising a potato product, a bean product, and a liquid. The potato product, the bean product, and the liquid may be present in the food composition in a consistency similar to that of conventional mashed potatoes. The nutritional value and/or the flavor of the food composition may be enhanced through the addition of additives, such as a calcium-containing compound, folic acid or a salt thereof, a vitamin, a mineral, a salt, a flavoring, butter, margarine, and any combination of at least two thereof.

One means of making the healthful benefits of legumes readily available is to incorporate legumes into the types of convenient, inexpensive, and readily available tuber-containing foods. One popular convenience tuber-containing food to which legumes could be added is instant mashed potatoes. By replacing a portion of the potato powder or flakes contained in conventional instant mashed potato products with edible legume products, the consumer is able to benefit from the additional nutrients provided by legumes without forgoing convenience or taste.

For example, a consumer may prepare nutritionally fortified mashed potatoes by mixing a portion of a pre-packaged composition containing a dehydrated potato product and dehydrated legumes with water, milk, cream, and any mixture thereof. The packages containing the dehydrated potatoes and legumes may be separate or mixed in a single package. The consumer may also add butter or margarine and salt to the mixture to enhance the flavor. The mixture may be brought to a boil, such as in a microwave oven or on a stovetop, and stirred until it reaches the consistency of mashed potatoes. In another embodiment, the liquid mixture, which may include butter and salt, may be brought to a boil separately from the dehydrated potato and legume product. The heated mixture may be removed from the heat source, and a portion of pre-packaged composition of tubers and legumes may be stirred into the liquid mixture to form nutritionally enhanced mashed potatoes.

The present disclosure may be further understood by reference to the following examples. The following examples are merely illustrative and are not intended to be limiting. Unless otherwise indicated, all percentages are expressed as a weight.

### EXAMPLES

Generally, mashed potatoes can be prepared any way known in the art or disclosed herein. For the following examples, the instructions for preparing mashed potatoes of the various embodiments were generally as follows in Table 5 below. Table 6 lists the nutrition facts for Betty Crocker POTATO BUDS™ which are used in certain examples disclosed herein. See Table 6A for dry POTATO BUDS™ and Table 6B for hydrated and prepared POTATO BUDS™. The ingredient statement for a single 23 gram serving of POTATO BUDS™ is shown in Table 7A (dry) and 7B (prepared).

TABLE 5

| | | | | SALT* | INSTANT | |
|---|---|---|---|---|---|---|
| | | | MARGARINE | (use less if | MASHED | MICROWAVE |
| SERVINGS | WATER | MILK | OR BUTTER | desired) | POTATOES | TIMES |
| About 2 | ⅔ cup | 2 Tbsp | 1 Tbsp | ¼ tsp | ⅔ cup | 1 to 2 minutes |
| 3 or 4 | 1⅓ | ⅓ cup | 2 Tbsp | ½ tsp | 1⅓ cups | 2 to 3 minutes |
| | cups | | | | | |
| 6 or 7 | 2⅔ | ⅔ cup | ¼ cup | 1 tsp | 2⅔ cups | 4 to 5 minutes |
| | cups | | | | | |
| 16 or 17 | 6½ | 1¼ | ½0 cup | 2 tsp | Entire package | Microwaving not |
| (Greater than | cups | cups | | | | recommended |
| 17)** | | | | | | |

*Sodium content per serving without salt is 120 mg for regular recipe and 75 mg for reduced-fat recipe.
**If making more than 17 servings, heat ingredients in Dutch oven, and whip potatoes, using wire
whisk.

| STOVE-TOP DIRECTIONS | MICROWAVE DIRECTIONS |
|---|---|
| HEAT water, milk, margarine, and salt to boiling | STIR hot water, instant mashed potatoes, milk, |
| in saucepan. | margarine and salt in microwavable bowl until |
| REMOVE from heat. Stir in instant mased | moistened. |
| potatoes just until moistened. Let stand about | COVER with plastic wrap, turning back one side to |
| 30 seconds or until liquid is absorbed. | vent steam. Microwave on High as directed in |
| WHIP with fork until as fluffy as descried. | chart above or until hot and bubbly. |
| | REMOVE carefully from microwave; bowl and |
| | potatoes will be hot. Whip with fork until as fluffy |
| | as desired. |

Extra-Creamy Recipe: Stir in additional milk, 1 tablespoon at a time, until as creamy as desired.
Reduced-Fat Recipe: Use fat-free (skim) milk, and for about 2 servings, use 1½ teaspoons margarine;
for 3 or 4 servings, use 1 tablespoon margarine; for 6 or 7 servings, use 2 tablespoons margarine; for 16
or 17 servings, use 5 tablespoons margarine. As prepared, one serving provides 120 calories (35
calories from fat), 4 g fat (1 g saturated, 0 g trans), 0 mg cholesterol and 420 mg sodium. (Regular
recipe provides 8 g fat per serving)
High Altitude (3,500-6,500 ft): Stove-Top Directions: No change. Microwave Directions: Increase
microwave time by 30 seconds (potatoes will be hot but not bubbly).

TABLE 6A
MASHED POTATOES, Dehydrated flakes without milk, dry

| | | | | Amount in edible | | |
|---|---|---|---|---|---|---|
| | | | | portion of common | | Amount in edible |
| | Amount in 100 grams, | | | measures of food | | portion of |
| | edible portion | | | Approximate | | 1 pound of food as |
| | | Standard | Number | measure and weight: | | purchased |
| Nutrients and units | Mean | error | of samples | ½ c = 22 g | 1 c = 45 g | Refuse: 0 |
| (A) | (B) | (C) | (D) | (E) | (F) | (G) |
| Proximate: | | | | | | |
| Water g | 6.51 | 0.523 | 26 | 1.43 | 2.93 | 29.52 |
| Food energy kcal | 354 | | | 78 | 159 | 1,605 |
| kJ | 1,481 | | | 326 | 666 | 6,717 |
| Protein (N × 6.25) g | 8.35 | 0.155 | 19 | 1.84 | 3.76 | 37.89 |
| Total lipid (fat) g | 0.39 | 0.148 | 15 | 0.09 | 0.18 | 1.78 |
| Carbohydrate, total g | 81.21 | | | 17.87 | 36.54 | 368.36 |
| Crude fiber g | 1.83 | 0.230 | 2 | 0.40 | 0.82 | 8.30 |
| Ash g | 3.54 | 0.111 | 14 | 0.78 | 1.59 | 16.06 |
| Minerals: | | | | | | |
| Calcium mg | 25 | 4.237 | 15 | 5 | 11 | 113 |
| Iron mg | 1.20 | 0.125 | 23 | 0.26 | 0.54 | 5.43 |
| Magnesium mg | 65 | 6.317 | 23 | 14 | 29 | 296 |
| Phosphorus mg | 154 | 14.691 | 25 | 34 | 69 | 698 |
| Potassium mg | 1,084 | 154.397 | 16 | 239 | 488 | 4,918 |
| Sodium mg | 107 | 16.111 | 16 | 24 | 48 | 487 |
| Zinc mg | 0.68 | 0.043 | 10 | 0.15 | 0.30 | 3.07 |
| Copper mg | 0.157 | 0.007 | 9 | 0.035 | 0.071 | 0.713 |
| Manganese mg | 0.102 | 0.004 | 5 | 0.022 | 0.046 | 0.463 |
| Vitamins: | | | | | | |
| Ascorbic acid¹ mg | 83.6 | 15.832 | 28 | 18.4 | 37.6 | 379.1 |
| Thiamin mg | 1.031 | 0.483 | 19 | 0.227 | 0.464 | 4.677 |
| Riboflavin mg | 0.110 | 0.013 | 24 | 0.024 | 0.049 | 0.498 |
| Niacin mg | 6.146 | 0.589 | 24 | 1.352 | 2.766 | 27.877 |
| Pantothenic acid mg | 2.117 | 0.212 | 10 | 0.466 | 0.953 | 9.605 |
| Vitamin B-6 mg | 0.762 | 0.124 | 16 | 0.168 | 0.343 | 3.459 |
| Folacin mcg | 40 | 5.364 | 3 | 9 | 18 | 183 |
| Vitamin B-12 mcg | 0 | | 1 | 0 | 0 | 0 |
| Vitamin A RE | | | | | | |
| IU | | | | | | |
| Lipids: | | | | | | |
| Fatty acids: | | | | | | |
| Saturated, total g | 0.100 | | | 0.022 | 0.045 | 0.454 |
| 4:0 g | | | | | | |
| 6:0 g | | | | | | |
| 8:0 g | | | | | | |
| 10:0 g | 0.003 | | 1 | 0.001 | 0.001 | 0.012 |
| 12:0 g | 0.014 | | 1 | 0.003 | 0.006 | 0.063 |
| 14:0 g | 0.003 | | 1 | 0.001 | 0.001 | 0.012 |
| 16:0 g | 0.066 | | 1 | 0.015 | 0.030 | 0.301 |
| 18:0 g | 0.014 | | 1 | 0.003 | 0.007 | 0.066 |
| Monounsaturated, total g | 0.008 | | | 0.002 | 0.004 | 0.036 |
| 16:1 g | 0.003 | | 1 | 0.001 | 0.001 | 0.015 |
| 18:1 g | 0.005 | | 1 | 0.001 | 0.002 | 0.021 |
| 20:1 g | | | | | | |
| 22:1 . . . g | | | | | | |
| Polyunsaturated, total g | 0.172 | | | 0.038 | 0.078 | 0.782 |
| 18:2 g | 0.131 | | 1 | 0.029 | 0.059 | 0.594 |
| 18:3 g | 0.041 | | 1 | 0.009 | 0.019 | 0.188 |
| 18:4 g | | | | | | |
| 20:4 g | | | | | | |
| 20:5 g | | | | | | |
| 22:5 g | | | | | | |
| 22:6 g | | | | | | |
| Cholesterol mg | 0 | | 1 | 0 | 0 | 0 |
| Phytosterols mg | | | | | | |
| Amino acids: | | | | | | |
| Tryptophan g | 0.086 | | | 0.019 | 0.038 | 0.388 |
| Threonine g | 0.372 | | | 0.082 | 0.167 | 1.686 |
| Isoleucine g | 0.425 | | | 0.094 | 0.191 | 1.928 |
| Leucine g | 0.659 | | | 0.145 | 0.297 | 2.989 |
| Lysine g | 0.583 | | | 0.128 | 0.262 | 2.644 |
| Methionine g | 0.142 | | | 0.031 | 0.064 | 0.643 |
| Cystine g | 0.098 | | | 0.021 | 0.044 | 0.443 |
| Phenylalanine g | 0.394 | | | 0.087 | 0.177 | 1.789 |
| Tyrosine g | 0.361 | | | 0.079 | 0.162 | 1.637 |
| Valine g | 0.521 | | | 0.115 | 0.235 | 2.365 |
| Arginine g | 0.369 | | | 0.081 | 0.166 | 1.673 |
| Histidine g | 0.203 | | | 0.045 | 0.091 | 0.922 |
| Alanine g | 0.299 | | | 0.066 | 0.135 | 1.358 |
| Aspartic acid g | 1.293 | | | 0.284 | 0.582 | 5.863 |
| Glutamic acid g | 1.547 | | | 0.340 | 0.696 | 7.015 |
| Glycine g | 0.247 | | | 0.054 | 0.111 | 1.122 |
| Proline g | 0.503 | | | 0.111 | 0.226 | 2.280 |
| Serine g | 0.389 | | | 0.086 | 0.175 | 1.764 |

¹Value varies widely depending on content of ascorbic acid in raw potatoes, method of processing, and length of storage of the dehydrated product.

TABLE 6B
MASHED POTATOES, Dehydrated flakes without milk, prepared²

| | | | | Amount in edible portion of | | Amount in edible |
|---|---|---|---|---|---|---|
| | Amount in 100 grams, | | | common measures of food | | portion of |
| | edible portion | | | Approximate measure and | | 1 pound of food as |
| | | Standard | Number | weight: | | purchased |
| Nutrients and units | Mean | error | of samples | ½ c = 105 g | 1 c = 210 g | Refuse: 0 |
| (A) | (B) | (C) | (D) | (E) | (F) | (G) |
| Proximate: | | | | | | |
| Water g | 76.30 | 1.689 | 5 | 80.12 | 160.23 | 346.11 |
| Food energy kcal | 113 | | | 118 | 237 | 511 |
| kJ | 472 | | | 495 | 990 | 2,139 |
| Protein (N × 6.26) g | 1.90 | 0.050 | 6 | 2.00 | 4.00 | 8.63 |
| Total lipid (fat) g | 5.60 | 0.300 | 6 | 5.88 | 11.76 | 25.40 |
| Carbohydrate, total g | 15.02 | | | 15.77 | 31.54 | 68.13 |
| Crude fiber g | 0.47 | | | 0.50 | 1.00 | 2.15 |
| Ash g | 1.18 | 0.092 | 6 | 1.23 | 2.47 | 5.33 |
| Minerals: | | | | | | |
| Calcium mg | 49 | 2.558 | 6 | 52 | 103 | 223 |
| Iron mg | 0.22 | | | 0.23 | 0.46 | 1.00 |
| Magnesium mg | 18 | | | 19 | 37 | 81 |
| Phosphorus mg | 56 | | | 59 | 118 | 254 |
| Potassium mg | 233 | 6.553 | 12 | 245 | 490 | 1,057 |
| Sodium mg | 332 | 2.870 | 17 | 349 | 697 | 1,506 |
| Zinc mg | 0.18 | | | 0.18 | 0.37 | 0.80 |
| Copper mg | 0.016 | | | 0.017 | 0.034 | 0.073 |
| Manganese mg | | | | | | |
| Vitamins: | | | | | | |
| Ascorbic acid mg | 9.7 | 3.810 | 6 | 10.2 | 20.4 | 44.0 |
| Thiamin mg | 0.111 | | | 0.117 | 0.233 | 0.503 |
| Riboflavin mg | 0.050 | 0.002 | 6 | 0.053 | 0.105 | 0.229 |
| Niacin mg | 0.670 | 0.024 | 6 | 0.704 | 1.407 | 3.039 |
| Pantothenic acid mg | 0.120 | | | 0.126 | 0.252 | 0.544 |
| Vitamin B-6 mg | 0.009 | | | 0.009 | 0.019 | 0.041 |
| Folacin mcg | 7.4 | | | 7.8 | 15.5 | 33.6 |
| Vitamin B-12 mcg | 0.078 | | | 0.082 | 0.164 | 0.354 |
| Vitamin A RE | 21 | | | 22 | 44 | 95 |
| IU | 180 | | | 189 | 378 | 817 |
| Lipids: | | | | | | |
| Fatty acids: | | | | | | |
| Saturated, total g | 3.434 | | | 3.606 | 7.211 | 15.577 |
| 4:0 g | 0.176 | | | 0.185 | 0.370 | 0.798 |
| 6:0 g | 0.105 | | | 0.110 | 0.221 | 0.476 |
| 8:0 g | 0.061 | | | 0.054 | 0.128 | 0.277 |
| 10:0 g | 0.138 | | | 0.145 | 0.290 | 0.626 |
| 12:0 g | 0.157 | | | 0.165 | 0.330 | 0.712 |
| 14:0 g | 0.552 | | | 0.580 | 1.159 | 2.504 |
| 16:0 g | 1.458 | | | 1.531 | 3.062 | 6.613 |
| 18:0 g | 0.670 | | | 0.704 | 1.407 | 3.039 |
| Monounsaturated, total g | 1.583 | | | 1.662 | 3.324 | 7.180 |
| 16:1 g | 0.122 | | | 0.128 | 0.256 | 0.553 |
| 18:1 g | 1.378 | | | 1.447 | 2.894 | 6.251 |
| 20:1 g | | | | | | |
| 22:1 g | | | | | | |
| Polyunsaturated, total g | 0.248 | | | 0.260 | 0.521 | 1.125 |
| 18:2 g | 0.156 | | | 0.164 | 0.328 | 0.708 |
| 18:3 g | 0.092 | | | 0.097 | 0.193 | 0.417 |
| 18:4 g | | | | | | |
| 20:4 g | | | | | | |
| 20:5 g | | | | | | |
| 22:5 g | | | | | | |
| 22:6 g | | | | | | |
| Cholesterol mg | 14 | | | 15 | 29 | 64 |
| Phytosterols mg | | | | | | |
| Amino acids: | | | | | | |
| Tryptophan g | 0.019 | | | 0.020 | 0.040 | 0.086 |
| Threonine g | 0.085 | | | 0.089 | 0.179 | 0.386 |
| Isoleucine g | 0.097 | | | 0.102 | 0.204 | 0.440 |
| Leucine g | 0.150 | | | 0.158 | 0.315 | 0.680 |
| Lysine g | 0.133 | | | 0.140 | 0.279 | 0.603 |
| Methionine g | 0.032 | | | 0.034 | 0.067 | 0.145 |
| Cystine g | 0.022 | | | 0.023 | 0.046 | 0.100 |
| Phenylalanine g | 0.090 | | | 0.095 | 0.189 | 0.408 |
| Tyrosine g | 0.082 | | | 0.086 | 0.172 | 0.372 |
| Valine g | 0.119 | | | 0.125 | 0.250 | 0.540 |
| Arginine g | 0.084 | | | 0.088 | 0.176 | 0.381 |
| Histidine g | 0.046 | | | 0.048 | 0.097 | 0.209 |
| Alanine g | 0.068 | | | 0.071 | 0.143 | 0.308 |
| Aspartic acid g | 0.294 | | | 0.309 | 0.617 | 1.334 |
| Glutamic acid g | 0.352 | | | 0.370 | 0.739 | 1.597 |
| Glycine g | 0.056 | | | 0.059 | 0.118 | 0.254 |
| Proline g | 0.114 | | | 0.120 | 0.239 | 0.517 |
| Serine g | 0.088 | | | 0.092 | 0.185 | 0.399 |

²Water and butter added.

TABLE 7A
INGREDIENT STATEMENT (Dry)

| | | |
|---|---|---|
| Name: Betty Crocker Potato Buds, dried | ESHA Code: | USDA Code: |
| Nutrients per wgt value: 23.00 | User Code: | Last Modified Date: |

Nutrients

| | | | | | |
|---|---|---|---|---|---|
| Gram Weight | 23.00 | g | Vitamin B12 | — | mcg |
| Calories | 80.00 | kcal | Biotin | — | mcg |
| Calories from Fat | 0 | kcal | Vitamin C | — | mg |
| Calories from SatFat | 0 | kcal | Vitamin D - IU | — | IU |
| Protein | 2.00 | g | Vitamin D - mcg | — | mcg |
| Carbohydrates | 18.00 | g | Vitamin E - Alpha-Toco | — | mg |
| Dietary Fiber | 1.00 | g | Folate | — | mcg |
| Soluble Fiber | — | g | Folate, DFE | — | mcg |
| Total Sugars | 0 | g | Vitamin K | — | mcg |
| Monosaccharides | — | g | Pantothenic Acid | — | mg |
| Disaccharides | — | g | Calcium | — | mg |
| Other Carbs | — | g | Chromium | — | mcg |
| Fat | 0 | g | Copper | — | mg |
| Saturated Fat | 0 | g | Fluoride | — | mg |
| Mono Fat | — | g | Iodine | — | mcg |
| Poly Fat | — | g | Iron | 0.36 | mg |
| Trans Fatty Acid | 0 | g | Magnesium | — | mg |
| Cholesterol | 0 | mg | Manganese | — | mg |
| Water | — | g | Molybdenum | — | mcg |
| Vitamin A - IU | — | IU | Phosphorus | — | mg |
| Vitamin A - RE | — | RE | Potassium | 330.00 | mg |
| Vitamin A - RAE | — | RAE | Selenium | — | mcg |
| Vitamin A - Carotenoid RE | — | RE | Sodium | 20.00 | mg |
| Vitamin A - Retinol RE | — | RE | Zinc | — | mg |
| Beta-Carotene | — | mcg | Omega 3 Fatty Acid | — | g |
| Vitamin B1 - Thiamin | — | mg | Omega 6 Fatty Acid | — | g |
| Vitamin B2 - Riboflavin | — | mg | Alcohol | — | g |
| Vitamin B3 - Niacin | — | mg | Caffeine | — | mg |
| Niacin Equivalents | — | mg | Choline | — | mg |
| Vitamin B6 | — | mg | | | |

Yields, Measures and Costs

Betty Crocker Potato Buds, dried
Total Yield: 100%
Cooked Yield: 100%
% Refuse: 0%

| | | |
|---|---|---|
| Name: Betty Crocker Potato Buds, dried | ESHA Code: | USDA Code: |
| Nutrients per wgt value: 23.00 | User Code: | Last Modified Date: |

Pyramid

| | |
|---|---|
| Pyramid - Fat | Pyramid - Meat |
| Pyramid - Bread | Pyramid - Milk |
| Pyramid - Fruit | Pyramid - Vegetables |

Exchanges

| | |
|---|---|
| Exchange - Fruit | Exchange - Other Carbs |
| Exchange - Meat | Exchange - Starch |
| Exchange - Very Lean Meat | Exchange - Vegetables |
| Exchange - Milk | Exchange - Fat |

Groups
Notes

Idaho potatoes, mono and diglycerides (to improve texture). Freshness protected
by sodium bisulfite and BHT.

Allergens

Allergens: Egg, Fish, Milk, Peanut, Shellfish, Soy, Treenuts, Wheat.

Ingredient Statement

Potato Bud 100% real Idaho Potatoes
*Idaho Potatoes, Mono and Diglycerides (To improve texture). Freshness protected by
sodium bisulfite and BHT.
*dried

TABLE 7B
INGREDIENT STATEMENT (Prepared)

| | | |
|---|---|---|
| Name: Betty Crocker Potato Buds Mashed Potatoes | ESHA Code: | USDA Code: |
| Nutrients per wgt value: 23.00 | User Code: | Last Modified Date: |

Nutrients

| | | | | | |
|---|---|---|---|---|---|
| Gram Weight | 23.00 | g | Vitamin B12 | — | mcg |
| Calories | 160.00 | kcal | Biotin | — | mcg |
| Calories from Fat | 160.00 | kcal | Vitamin C | — | mg |
| Calories from SatFat | — | kcal | Vitamin D - IU | — | IU |
| Protein | 2.00 | g | Vitamin D - mcg | — | mcg |
| Carbohydrates | 18.00 | g | Vitamin E - Alpha-Toco | — | mg |
| Dietary Fiber | 1.00 | g | Folate | — | mcg |
| Soluble Fiber | — | g | Folate, DFE | — | mcg |
| Total Sugars | — | g | Vitamin K | — | mcg |
| Monosaccharides | — | g | Pantothenic Acid | — | mg |
| Disaccharides | — | g | Calcium | 20.00 | mg |
| Other Carbs | — | g | Chromium | — | mcg |
| Fat | 70.00 | g | Copper | — | mg |
| Saturated Fat | — | g | Fluoride | — | mg |
| Mono Fat | — | g | Iodine | — | mcg |
| Poly Fat | — | g | Iron | 0.36 | mg |
| Trans Fatty Acid | — | g | Magnesium | — | mg |
| Cholesterol | 10.00 | mg | Manganese | — | mg |
| Water | 190.00 | g | Molybdenum | — | mcg |
| Vitamin A - IU | 300.00 | IU | Phosphorus | — | mg |
| Vitamin A - RE | — | RE | Potassium | — | mg |
| Vitamin A - RAE | — | RAE | Selenium | — | mcg |
| Vitamin A - Carotenoid RE | — | RE | Sodium | — | mg |
| Vitamin A - Retinol RE | — | RE | Zinc | — | mg |
| Beta-Carotene | — | mcg | Omega 3 Fatty Acid | — | g |
| Vitamin B1 - Thiamin | — | mg | Omega 6 Fatty Acid | — | g |
| Vitamin B2 - Riboflavin | — | mg | Alcohol | — | g |
| Vitamin B3 - Niacin | — | mg | Caffeine | — | mg |
| Niacin Equivalents | — | mg | Choline | — | mg |
| Vitamin B6 | — | mg | | | |

Yields, Measures and Costs

Betty Crocker Potato Buds Mashed Potatoes, prepared
Total Yield: 100%
Cooked Yield: 100%
% Refuse: 0%

| | | |
|---|---|---|
| Name: Betty Crocker Potato Buds Mashed Potatoes | ESHA Code: | USDA Code: |
| Nutrients per wgt value: 23.00 | User Code: | Last Modified Date: |

Pyramid

| | |
|---|---|
| Pyramid - Fat | Pyramid - Meat |
| Pyramid - Bread | Pyramid - Milk |
| Pyramid - Fruit | Pyramid - Vegetables |

Exchanges

| | |
|---|---|
| Exchange - Fruit | Exchange - Other Carbs |
| Exchange - Meat | Exchange - Starch |
| Exchange - Very Lean Meat | Exchange - Vegetables |
| Exchange - Milk | Exchange - Fat |

Groups
Notes
Allergens

Allergens: Egg, Fish, Milk, Peanut, Shellfish, Soy, Treenuts, Wheat.

Ingredient Statement

### Example 1

POTATO BUDS™ (Betty Crocker, Norwalk, Conn.) instant potato flakes (i.e., potatoes, mono and diglycerides, sodium bisulfite, and BHA) and Pinto Bean Powder (Cat. No. 192001-80M, ADM, Decatur, Ill.) were blended at a 75:25 ratio, respectively. Nutritional information was calculated using Genesis® Software for mashed potatoes, dehydrated flakes (Garuda International, Inc. Exter, Calif.). See Tables 8A-8E below.

TABLE 8A
INGREDIENTS (Dry)
75% Betty Crocker Potato Buds, 25% Pinto Beans, dry
Number of Servings: 1 (23 g per serving)

| Amount Measure | Ingredient |
|---|---|
| 17.25 g | Betty Crocker Potato Buds, as packaged |
| 5.75 g | Precooked Pinto Bean Powder |
| | 192001-80M |

TABLE 8B
NUTRITION INFORMATION (Dry)
75% Betty Crocker Potato Buds, 25% Pinto Beans, dry
Number of Servings: 1 (23 g per serving)

| Nutrition Facts | |
|---|---|
| Serving Size (23 g) | |
| Servings Per Container | |
| Amount Per Serving | |
| Calories 80 | Calories from Fat 0 |
| | % Daily Value* |
| Total Fat 0 g | 0% |
| Saturated Fat 0 g | 0% |
| Trans Fat 0 g | |
| Cholesterol 0 mg | 0% |
| Sodium 15 mg | 1% |
| Total Carbohydrate 17 g | 6% |
| Dietary Fiber 2 g | 8% |
| Sugars 0 g | |
| Protein 3 g | |
| Vitamin A 0% | Vitamin C 0% |
| Calcium 2% | Iron 4% |

*Percent Daily Values are based on a 2,000 calorie diet. Your daily
values may be higher or lower depending on your calorie needs:

| | Calories | 2,000 | | 2,500 | |
|---|---|---|---|---|---|
| Total Fat | Less | 65 | g | 80 | g |
| | Than | | | | |
| Saturated Fat | Less | 20 | g | 25 | g |
| | Than | | | | |
| Cholesterol | Less | 300 | mg | 300 | mg |
| | Than | | | | |
| Sodium | Less | 2,400 | mg | 2,400 | mg |
| | Than | | | | |
| Total | | 300 | g | 375 | g |
| Carbohydrate | | 25 | g | 30 | g |
| Dietary Fiber | | | | | |

Calories per gram:
Fat 9 · Carbohydrate 4 · Protein 4

TABLE 8C
INGREDIENTS (Prepared)
75% Betty Crocker Potato Buds, 25% Pinto Beans, prepared
Number of Servings: 1 (23 g per serving)

| Amount Measure | Ingredient |
|---|---|
| 30.75 g | Betty Crocker Potato Buds, dried |
| 10.75 g | Precooked Pinto Bean Powder |
| | 192001-80M |
| 1.19 g | Salt, table, iodized |
| 28.60 g | Butter, unsalted, stick |
| 30.00 g | Milk, 2%, w/add vit A & D |
| 173.85 g | Water, municipal |

TABLE 8D
NUTRITION INFORMATION (Prepared)
75% Betty Crocker Potato Buds, 25% Pinto Beans, prepared
Number of Servings: 1 (23 g per serving)

| Nutrition Facts | |
|---|---|
| Serving Size (23 g) | |
| Serving Per Container | |
| Amount Per Serving | |
| Calories 30 | Calories from Fat |
| | 20 |
| | % Daily Value* |
| Total Fat 2 g | 3% |
| Saturated Fat 1.5 g | 8% |
| Trans Fat 0 g | |
| Cholesterol 5 mg | 2% |
| Sodium 40 mg | 2% |
| Total Carbohydrate 3 g | 1% |
| Dietary Fiber 0 g | 0% |
| Sugars 0 g | |
| Protein 1 g | |
| Vitamin A 2% | Vitamin C 0% |
| Calcium 0% | Iron 0% |

*Percent Daily Values are based on a 2,000 calorie diet. Your daily
values may be higher or lower depending on your calorie needs:

| | Calories | 2,000 | | 2,500 | |
|---|---|---|---|---|---|
| Total Fat | Less | 65 | g | 80 | g |
| | Than | | | | |
| Saturated Fat | Less | 20 | g | 25 | g |
| | Than | | | | |
| Cholesterol | Less | 300 | mg | 300 | mg |
| | Than | | | | |
| Sodium | Less | 2,400 | mg | 2,400 | mg |
| | Than | | | | |
| Total | | 300 | g | 375 | g |
| Carbohydrate | | 25 | g | 30 | g |
| Dietary Fiber | | | | | |

Calories per gram:
Fat 9 · Carbohydrate 4 · Protein 4

TABLE 8E
INGREDIENT STATEMENT (Prepared)
75% Betty Crocker Potato Buds, 25% Pinto Beans, prepared
Number of Servings: 1 (23 g per serving)
Weight: 275.14 g
Ingredient Statement

INGREDIENTS: Water, Potato bud 100% real Idaho Potatoes *Idaho
Potatoes, Mono and Diglycerides (To improve texture). Freshness
protected by sodium bisulfite and BHT.
*dried, Milk, 2%, w/add vit A & D, Butter, Whole Pinto Bean Powder
(Sugar, Calcium Chloride), Salt, table, iodized.

Allergen Statement

Contains Egg, Fish, Milk, Peanut, Shellfish, Soy, Treenuts, Wheat.

Ingredients by Percent Weight

| | | | |
|---|---|---|---|
| 63.186014 | Water | 10.394708 | Butter |
| 11.176129 | Whole Pinto Bean | 3.907102 | Potato bud 100% real |
| | Powder (Sugar, Calcium | | Idaho Potatoes |
| | Chloride) | | *Idaho Pot |
| 10.90354 | Milk, 2%, w/add vit A D | 0.432507 | Salt, table, iodized |

Nutrients

| | | | | | |
|---|---|---|---|---|---|
| Gram Weight | 23.00 | g | Dietary Fiber | 0.33 | g |
| Calories | 30.02 | kcal | Soluble Fiber | 0.06 | g |
| Calories from Fat | 17.77 | kcal | Total Sugars | 0.15 | g |
| Calories from SatFat | 11.38 | kcal | Monosaccharides | 0.00 | g |
| Protein | 0.53 | g | Disaccharides | 0.12 | g |
| Carbohydrates | 2.71 | g | Other Carbs | 0.02 | g |
| Fat | 2.01 | g | Folate | 0.88 | mcg |
| Saturated Fat | 1.26 | g | Folate, DFE | 0.20 | mcg |
| Mono Fat | 0.52 | g | Vitamin K | 0.17 | mcg |
| Poly Fat | 0.09 | g | Pantothenic Acid | 0.01 | mg |
| Trans Fatty Acid | 0.06 | g | Calcium | 5.57 | mg |
| Cholesterol | 5.34 | mg | Chromium | 0.03 | mcg |
| Water | 17.25 | g | Copper | 0.01 | mg |
| Vitamin A - IU | 64.55 | IU | Fluoride | — | mg |
| Vitamin A - RE | 18.06 | RE | Iodine | 5.11 | mcg |
| Vitamin A - RAE | 17.74 | RAE | Iron | 0.09 | mg |
| Vitamin A - | 0.63 | RE | Magnesium | 1.64 | mg |
| Carotenoid RE | | | | | |
| Vitamin A - Retinol RE | 17.42 | RE | Manganese | 0.00 | mg |
| Beta-Carotene | 3.85 | mcg | Molybdenum | 0.05 | mcg |
| Vitamin B1 - Thiamin | 0.00 | mg | Phosphorus | 6.55 | mg |
| Vitamin B2 - Riboflavin | 0.01 | mg | Potassium | 49.48 | mg |
| Vitamin B3 - Niacin | 0.00 | mg | Selenium | 0.09 | mcg |
| Niacin Equivalents | 0.03 | mg | Sodium | 43.28 | mg |
| Vitamin B6 | 0.00 | mg | Zinc | 0.04 | mg |
| Vitamin B12 | 0.02 | mcg | Omega 3 Fatty | 0.01 | g |
| | | | Acid | | |
| Biotin | 0.05 | mcg | Omega 6 Fatty | 0.07 | g |
| | | | Acid | | |
| Vitamin C | 0.03 | mg | Alcohol | 0 | g |
| Vitamin D - IU | 1.08 | IU | Caffeine | 0 | mg |
| Vitamin D - mcg | 0.03 | mcg | Choline | 0.41 | mg |
| Vitamin E - Alpha-Toco | 0.06 | mg | | | |

Yields, Measures and Costs

25% Pinto Beans and 75% Potato Buds, prepared
Total Yield: 100%
Cooked Yield: 100%
% Refuse: 0%
Measures:
1.00 Serving = 23.00 g

Pyramid

| | | | |
|---|---|---|---|
| Pyramid - Fat | 0.17 | Pyramid - Meat | |
| Pyramid - Brad | | Pyramid - Milk | 0.01 |
| Pyramid - Fruit | | Pyramid - Vegetables | |

Exchanges

| | | | |
|---|---|---|---|
| Exchange - Fruit | | Exchange - Other Carbs | |
| Exchange - Meat | | Exchange - Starch | |
| Exchange - Very Lean Meat | | Exchange - Vegetables | |
| Exchange - Milk | 0.01 | Exchange - Fat | 0.39 |

Groups

### Example 2

POTATO BUDS™ (Betty Crocker, Norwalk, Conn.) instant potato flakes (i.e., potatoes, mono and diglycerides, sodium bisulfite, and BHA) and Pinto Bean Powder (Cat. No. 192001-80M, ADM, Decatur, Ill.) were blended at a 50:50 ratio. For a 23 gram serving size, the resultant blend increased the calcium 4 fold; the dietary fiber 6 fold; the protein 2 fold; the iron 2 fold; the magnesium 0.5 fold; and the zinc 2 fold over the POTATO BUDS™ alone. Nutritional information was calculated using Genesis® Software for mashed potatoes, dehydrated flakes (Garuda International, Inc. Exter, Calif.). See Tables 9A-9D below.

TABLE 9A
INGREDIENTS (Dry)
50% Pinto Beans, 50% Betty Crocker Potato Buds, dry
Number of Servings: (23 g per serving)

| Amount Measure | Ingredient |
|---|---|
| 11.50 g | Betty Crocker Potato Buds, as packaged |
| 11.50 g | Precooked Pinto Bean Powder |
| | 192001-80M |

TABLE 9B
NUTRITIONAL INFORMATION (Dry)
50% Pinto Beans and 50% Potato Buds, prepared
Number of Servings: (23 g per serving)

| Nutrition Facts | |
|---|---|
| Serving Size (23 g) | |
| Servings Per Container | |
| Amount Per Serving | |
| Calories 30 | Calories from Fat |
| | 20 |
| | % Daily Value* |
| Total Fat 2 g | 3% |
| Saturated Fat 1.5 g | 8% |
| Trans Fat 0 g | |
| Cholesterol 5 mg | 2% |
| Sodium 45 mg | 2% |
| Total Carbohydrate 3 g | 1% |
| Dietary Fiber 1 g | 4% |
| Sugars 0 g | |
| Protein 1 g | |
| Vitamin A 2% | Vitamin C 0% |
| Calcium 0% | Iron 0% |

*Percent Daily Values are based on a 2,000 calorie diet. Your daily
values may be higher or lower depending on your calorie needs:

| | Calories | 2,000 | | 2,500 | |
|---|---|---|---|---|---|
| Total Fat | Less | 65 | g | 80 | g |
| | Than | | | | |
| Saturated Fat | Less | 20 | g | 25 | g |
| | Than | | | | |
| Cholesterol | Less | 300 | mg | 300 | mg |
| | Than | | | | |
| Sodium | Less | 2,400 | mg | 2,400 | mg |
| | Than | | | | |
| Total | | 300 | g | 375 | g |
| Carbohydrate | | 25 | g | 30 | g |
| Dietary Fiber | | | | | |

Calories per gram:
Fat 9 · Carbohydrate 4 · Protein 4

TABLE 9C
INGREDIENTS (Prepared)
50% Pinto Beans, 50% Betty Crocker Potato Buds, dry
Number of Servings: (23 g per serving)

| Amount Measure | Ingredient |
|---|---|
| 11.50 g | Betty Crocker Potato Buds, as packaged |
| 11.50 g | Precooked Pinto Bean Powder |
| | 192001-80M |

TABLE 9D
NUTRITIONAL INFORMATION (Prepared)
50% Pinto Beans and 50% Potato Buds, prepared
Number of Servings: (23 g per serving)

| Nutrition Facts | |
|---|---|
| Serving Size (23 g) | |
| Servings Per Container | |
| Amount Per Serving | |
| Calories 30 | Calories from Fat |
| | 20 |
| | % Daily Value* |
| Total Fat 2 g | 3% |
| Saturated Fat 1.5 g | 8% |
| Trans Fat 0 g | |
| Cholesterol 5 mg | 2% |
| Sodium 45 mg | 2% |
| Total Carbohydrate 3 g | 1% |
| Dietary Fiber 1 g | 4% |
| Sugars 0 g | |
| Protein 1 g | |
| Vitamin A 2% | Vitamin C 0% |
| Calcium 0% | Iron 0% |

*Percent Daily Values are based on a 2,000 calorie diet. Your daily
values may be higher or lower depending on your calorie needs:

| | Calories | 2,000 | | 2,500 | |
|---|---|---|---|---|---|
| Total Fat | Less | 65 | g | 80 | g |
| | Than | | | | |
| Saturated Fat | Less | 20 | g | 25 | g |
| | Than | | | | |
| Cholesterol | Less | 300 | mg | 300 | mg |
| | Than | | | | |
| Sodium | Less | 2,400 | mg | 2,400 | mg |
| | Than | | | | |
| Total | | 300 | g | 375 | g |
| Carbohydrate | | 25 | g | 30 | g |
| Dietary Fiber | | | | | |

Calories per gram:
Fat 9 · Carbohydrate 4 · Protein 4

TABLE 9D
50% Pinto Beans and 50% Potato Buds, prepared
Number of Servings: 11.96 (23.00 g per serving)
Weight: 275.14 g
Ingredient Statement

INGREDIENTS: Water, Milk, 2%, w/add vit A & D, Butter, Potato Bud
100% real Idaho Potatoes *Idaho Potatoes, Mono and Diglycerides (To
improve texture). Freshness protected by sodium bisulfite and BHT.
*dried Whole Pinto Bean Powder (Sugar, Calcium Chloride), Salt,
table, iodized.

Allergen Statement

Contains Egg, Fish, Milk, Peanut, Shellfish, Soy, Treenuts, and Wheat.

Ingredients by Percent Weight

| | | | |
|---|---|---|---|
| 63.186014 | Water | 7.541615 | Potato Bud 100% real |
| | | | Idaho Potatoes *Idaho |
| | | | Potatoes |
| 10.90354 | Milk, 2%, w/add vit A D | 7.541615 | Pinto Bean Powder |
| | | | (Sugar, Calcium |
| | | | Chloride) |
| 10.394708 | Butter | 0.432507 | Salt, table, iodized |

Nutrients

| | | | | | |
|---|---|---|---|---|---|
| Gram Weight | 23.00 | g | Dietary Fiber | 0.50 | g |
| Calories | 29.62 | kcal | Soluble Fiber | 0.11 | g |
| Calories from Fat | 17.94 | kcal | Total Sugars | 0.19 | g |
| Calories from SatFat | 11.41 | kcal | Monosaccharides | 0.00 | g |
| Protein | 0.65 | g | Disaccharides | 0.12 | g |
| Carbohydrates | 2.60 | g | Other Carbs | 0.04 | g |
| Fat | 2.03 | g | Folate | 1.52 | mcg |
| Saturated Fat | 1.27 | g | Folate, DFE | 0.20 | mcg |
| Mono Fat | 0.52 | g | Vitamin K | 0.17 | mcg |
| Poly Fat | 0.10 | g | Pantothenic Acid | 0.01 | mg |
| Trans Fatty Acid | 0.06 | g | Calcium | 7.22 | mg |
| Cholesterol | 5.34 | mg | Chromium | 0.03 | mcg |
| Water | 17.31 | g | Copper | 0.01 | mg |
| Vitamin A - IU | 64.61 | IU | Fluoride | — | mg |
| Vitamin A - RE | 18.06 | RE | Iodine | 5.11 | mcg |
| Vitamin A - RAE | 17.74 | RAE | Iron | 0.12 | mg |
| Vitamin A - Carotenoid | 0.63 | RE | Magnesium | 2.72 | mg |
| RE | | | | | |
| Vitamin A - Retinol RE | 17.42 | RE | Manganese | 0.00 | mg |
| Beta-Carotene | 3.85 | mcg | Molybdenum | 0.05 | mcg |
| Vitamin B1 - Thiamin | 0.00 | mg | Phosphorus | 9.92 | mg |
| Vitamin B2 - Riboflavin | 0.01 | mg | Potassium | 45.16 | mg |
| Vitamin B3 - Niacin | 0.00 | mg | Selenium | 0.09 | mcg |
| Niacin Equivalents | 0.04 | mg | Sodium | 42.86 | mg |
| Vitamin B6 | 0.00 | mg | Zinc | 0.06 | mg |
| Vitamin B12 | 0.02 | mcg | Omega 3 Fatty | 0.01 | g |
| | | | Acid | | |
| Biotin | 0.05 | mcg | Omega 6 Fatty | 0.07 | g |
| | | | Acid | | |
| Vitamin C | 0.05 | mg | Alcohol | 0 | g |
| Vitamin D - IU | 1.08 | IU | Caffeine | 0 | mg |
| Vitamin D - mcg | 0.03 | mcg | Choline | 0.41 | mg |
| Vitamin E - Alpha-Toco | 0.06 | mg | | | |

Yields, Measures and Costs

50% Pinto Beans and 50% Potato Buds, prepared
Total Yield: 100%
Cooked Yield: 100%
% Refuse: 0%
Measures:
1.00 Serving = 23.00 g
Cost:

Pyramid

| | | | |
|---|---|---|---|
| Pyramid - Fat | 0.17 | Pyramid - Meat | |
| Pyramid - Brad | | Pyramid - Milk | 0.01 |
| Pyramid - Fruit | | Pyramid - Vegetables | |

Exchanges

| | | | |
|---|---|---|---|
| Exchange - Fruit | | Exchange - Other Carbs | |
| Exchange - Meat | | Exchange - Starch | |
| Exchange - Very Lean Meat | | Exchange - Vegetables | |
| Exchange - Milk | 0.01 | Exchange - Fat | 0.39 |

Groups

### Example 3

POTATO BUDS™ (Betty Crocker, Norwalk, Conn.) instant potato flakes (i.e., potatoes, mono and diglycerides, sodium bisulfite, and BHA) and Pinto Bean Powder (Cat. No. 192001-80M, ADM, Decatur, Ill.) were blended at a 25:75 ratio, respectively. Nutritional information was calculated using Genesis® Software for mashed potatoes, dehydrated flakes (Garuda International, Inc. Exter, Calif.). See Tables 10A-10E.

TABLE 10A
INGREDIENTS (Dry)
25% Betty Crocker Potato Buds, 75% Pinto Beans, dry

| Amount Measure | Ingredient |
|---|---|
| 5.75 g | Betty Crocker Potato Buds, as packaged |
| 17.25 g | Precooked Pinto Bean Powder |
| | 192001-80M |

TABLE 10B
NUTRITIONAL INFORMATION (Dry)
25% Betty Crocker Potato Buds, 75% Pinto Beans, dry

| Nutrition Facts | |
|---|---|
| Serving Size (23 g) | |
| Servings Per Container | |
| Amount Per Serving | |
| Calories 70 | Calories from Fat 5 |
| | % Daily Value* |
| Total Fat 0 g | 0% |
| Saturated Fat 0 g | 0% |
| Trans Fat 0 g | |
| Cholesterol 0 mg | 0% |
| Sodium 10 mg | 0% |
| Total Carbohydrate 16 g | 5% |
| Dietary Fiber 5 g | 20% |
| Sugars 1 g | |
| Protein 4 g | |
| Vitamin A 0% | Vitamin C 0% |
| Calcium 4% | Iron 6% |

*Percent Daily Values are based on a 2,000 calorie diet. Your daily
values may be higher or lower depending on your calorie needs:

| | Calories | 2,000 | | 2,500 | |
|---|---|---|---|---|---|
| Total Fat | Less | 65 | g | 80 | g |
| | Than | | | | |
| Saturated Fat | Less | 20 | g | 25 | g |
| | Than | | | | |
| Cholesterol | Less | 300 | mg | 300 | mg |
| | Than | | | | |
| Sodium | Less | 2,400 | mg | 2,400 | mg |
| | Than | | | | |
| Total | | 300 | g | 375 | g |
| Carbohydrate | | 25 | g | 30 | g |
| Dietary Fiber | | | | | |

Calories per gram:
Fat 9 · Carbohydrate 4 · Protein 4

TABLE 10C
INGREDIENTS (Prepared)
25% Potato Buds, 75% Pinto Beans prepared

| Amount Measure | Ingredient |
|---|---|
| 10.75 g | Betty Crocker Potato Buds, dried |
| 30.75 g | Precooked Pinto Bean Powder |
| | 192001-80M |
| 1.19 g | Salt, table, iodized |
| 28.60 g | Butter, unsalted, stick |
| 30.00 g | Milk, 2%, w/add vit A & D |
| 173.85 g | Water, municipal |

TABLE 10D
NUTRITIONAL INFORMATION (Prepared)
75% Pinto Beans, 25% Potato Buds, prepared

| Nutrition Facts | |
|---|---|
| Serving Size (23 g) | |
| Servings Per Container | |
| Amount Per Serving | |
| Calories 30 | Calories from Fat |
| | 20 |
| | % Daily Value* |
| Total Fat 2 g | 3% |
| Saturated Fat 1.5 g | 8% |
| Trans Fat 0 g | |
| Cholesterol 5 mg | 2% |
| Sodium 40 mg | 2% |
| Total Carbohydrate 2 g | 1% |
| Dietary Fiber 1 g | 4% |
| Sugars 0 g | |
| Protein 1 g | |
| Vitamin A 2% | Vitamin C 0% |
| Calcium 0% | Iron 0% |

*Percent Daily Values are based on a 2,000 calorie diet. Your daily
values may be higher or lower depending on your calorie needs:

| | Calories | 2,000 | | 2,500 | |
|---|---|---|---|---|---|
| Total Fat | Less | 65 | g | 80 | g |
| | Than | | | | |
| Saturated Fat | Less | 20 | g | 25 | g |
| | Than | | | | |
| Cholesterol | Less | 300 | mg | 300 | mg |
| | Than | | | | |
| Sodium | Less | 2,400 | mg | 2,400 | mg |
| | Than | | | | |
| Total | | 300 | g | 375 | g |
| Carbohydrate | | 25 | g | 30 | g |
| Dietary Fiber | | | | | |

Calories per gram:
Fat 9 · Carbohydrate 4 · Protein 4

TABLE 10E
INGREDIENT STATEMENT (Prepared)
75% Pinto Beans, 25% Potato Buds, prepared
Number of Servings: (23.00 g per serving)
Weight: 275.14 g
Ingredient Statement

INGREDIENTS: Water, Whole Pinto Bean Powder (Sugar,
Calcium Chloride), Milk, 2%, w/add vit A & D, Butter, Potato Bud
100% real Idaho Potatoes *Idaho Potatoes, Mono and Diglycerides
(To improve texture). Freshness protected by sodium bisulfite and BHT.
*dried Salt, table, iodized.

Allergen Statement

Contains Egg, Fish, Milk, Peanut, Shellfish, Soy, Treenuts, and Wheat.

Ingredients by Percent Weight

| | | | |
|---|---|---|---|
| 63.186014 | Water | 10.394708 | Butter |
| 11.176129 | Whole Pinto Bean | 3.907102 | Potato bud 100% real |
| | Powder (Sugar, | | Idaho Potatoes |
| | Calcium Chloride) | | *Idaho Pot |
| 10.90354 | Milk, 2%, w/add vit A D | 0.432507 | Salt, table, iodized |

Nutrients

| | | | | | |
|---|---|---|---|---|---|
| Gram Weight | 23.00 | g | Dietary Fiber | 0.67 | g |
| Calories | 29.21 | kcal | Soluble Fiber | 0.16 | g |
| Calories from Fat | 18.11 | kcal | Total Sugars | 0.22 | g |
| Calories from SatFat | 11.45 | kcal | Monosaccharides | 0.00 | g |
| Protein | 0.78 | g | Disaccharides | 0.12 | g |
| Carbohydrates | 2.49 | g | Other Carbs | 0.06 | g |
| Fat | 2.05 | g | Folate | 2.16 | mcg |
| Saturated Fat | 1.27 | g | Folate, DFE | .20 | mcg |
| Mono Fat | 0.52 | g | Vitamin K | 0.17 | mcg |
| Poly Fat | 0.11 | g | Pantothenic Acid | 0.01 | mg |
| Trans Fatty Acid | 0.06 | g | Calcium | 8.86 | mg |
| Cholesterol | 5.34 | mg | Chromium | 0.03 | mcg |
| Water | 17.37 | g | Copper | 0.02 | mg |
| Vitamin A - IU | 64.67 | IU | Fluoride | — | mg |
| Vitamin A - RE | 18.06 | RE | Iodine | 5.11 | mcg |
| Vitamin A - RAE | 17.74 | RAE | Iron | 0.15 | mg |
| Vitamin A - Carotenoid | 0.63 | RE | Magnesium | 3.81 | mg |
| RE | | | | | |
| Vitamin A - Retinol RE | 17.42 | RE | Manganese | 0.00 | mg |
| Beta- Carotene | 3.85 | mcg | Molybdenum | 0.05 | mcg |
| Vitamin B1 - Thiamin | 0.01 | mg | Phosphorus | 13.29 | mg |
| Vitamin B2 - Riboflavin | 0.01 | mg | Potassium | 40.85 | mg |
| Vitamin B3 - Niacin | 0.00 | mg | Selenium | 0.09 | mcg |
| Niacin Equivalents | 0.05 | mg | Sodium | 42.45 | mg |
| Vitamin B6 | 0.00 | mg | Zinc | 0.08 | mg |
| Vitamin B12 | 0.02 | mcg | Omega 3 Fatty | 0.01 | g |
| | | | Acid | | |
| Biotin | 0.05 | mcg | Omega 6 Fatty | 0.07 | g |
| | | | Acid | | |
| Vitamin C | 0.07 | mg | Alcohol | 0 | g |
| Vitamin D - IU | 1.08 | IU | Caffeine | 0 | mg |
| Vitamin D - mcg | 0.03 | mcg | Choline | 0.41 | mg |
| Vitamin E - Alpha- Toco | 0.06 | mg | | | |

Yields, Measures and Costs

25% Potato Buds, 75% Pinto Beans, prepared
Total Yield: 100%
Cooked Yield: 100%
% Refuse: 0%
Measures:
1.00 Serving = 23.00 g
Cost:

Pyramid

| | | | |
|---|---|---|---|
| Pyramid - Fat | 0.17 | Pyramid - Meat | |
| Pyramid - Brad | | Pyramid - Milk | 0.01 |
| Pyramid - Fruit | | Pyramid - Vegetables | |

Exchanges

| | | | |
|---|---|---|---|
| Exchange - Fruit | | Exchange - Other Carbs | |
| Exchange - Meat | | Exchange - Starch | |
| Exchange - Very Lean Meat | | Exchange - Vegetables | |
| Exchange - Milk | 0.01 | Exchange - Fat | 0.39 |

Groups

### Example 5

POTATO BUDS™ (Betty Crocker, Norwalk, Conn.) instant potato flakes and Pinto Bean Powder (Cat. No. 192001-80M, ADM, Decatur, Ill.) were blended at a 25:75, 50:50, and 75:25 ratios, respectively, as in the previous examples. These products were successfully tested in Pierogies, which are pasta pockets typically filled with mashed potatoes, cheese, and spices.

While this invention has been particularly shown and described with references to preferred embodiments thereof, it will be understood by those skilled in the art that various changes in form and details may be made therein without departing from the scope of the invention encompassed by the appended claims.

We claim:

1. A composition comprising:
a dehydrated tuber product; and
a dehydrated legume product.

2. The composition of claim 1, wherein the dehydrated legume product is selected from the group consisting of legume flakes, legume powder, whole legumes, legume pieces, and combinations of any thereof.

3. The composition of claim 1, wherein the dehydrated tuber product is selected from the group consisting of potato flakes, potato powder, yam flakes, yam powder, and combinations of any thereof.

4. The composition of any one of claim 1, further comprising:
a liquid selected from the group consisting of milk, water, and a combination thereof;
wherein the dehydrated tuber product, the dehydrated legume product, and the liquid are present in the composition such that the composition has a consistency of mashed potatoes.

5. The composition of claim 1, wherein the composition is whipped.

6. The composition of claim 1, wherein the composition comprises 25% to 99% of the dehydrated tuber product and 1% to 75% of the dehydrated legume product.

7. The composition of claim 1, wherein the legume from which the dehydrated legume product originates is a species selected from the group consisting of Glycine spp., Arachis spp., Lens spp., Pisum spp., Vicia spp., Cicer spp., Phaseolus spp., Vigna spp, and any combination thereof.

8. The composition of claim 1, wherein the legume is selected from the group consisting of shell beans, snap beans, string beans, pinto beans, Great Northern beans, navy beans, red beans, black beans, dark and light red kidney beans, fava beans, green baby lima beans, pink beans, myasi beans, black-eyed beans, garbanzo beans, cranberry beans, white beans, rice beans, butter beans, Adzuki beans, black-eyed peas, cowpeas, cannelini beans, chickpeas, fava beans, broad beans, Flageolet beans, mung beans, Soissons beans, soybeans, and combinations of any thereof.

9. The composition of claim 1, further comprising an ingredient selected from the group consisting of a calcium containing compound, folic acid or a salt thereof, a vitamin, a mineral, a salt, a flavoring, butter, margarine, and any combination thereof.

10. The composition of claim 1 1-3 or 6-9, wherein twenty-three grams of the composition comprises at least one gram of dietary fiber.

11. The composition of claim 10, wherein the twenty-three grams of the composition comprises at least two grams of dietary fiber.

12. The composition of claim 4, wherein two hundred ten grams of the composition comprises at least one gram of dietary fiber.

13. The composition of claim 4, wherein the two hundred ten grams of the composition comprises at least two grams of dietary fiber.

14-27. (canceled)

28. A food composition comprising:
a potato product;
an edible bean product; and
a liquid;
the potato product, the edible bean product, and the liquid being present in the food composition in such amounts to give the food composition a consistency of a mashed-potato product.

29. The food composition of claim 28, further comprising an ingredient selected from the group consisting of a calcium containing compound, folic acid or a salt thereof, a vitamin, a mineral, a salt, a flavoring, butter, margarine, and any combination thereof.

30. The food composition of claim 28, wherein two hundred ten grams of the food composition comprises at least one gram of dietary fiber.

31. The food composition of claim 28, wherein the bean is selected from the group consisting of shell beans, snap beans, string beans, pinto beans, Great Northern beans, navy beans, red beans, black beans, dark and light red kidney beans, fava beans, green baby lima beans, pink beans, myasi beans, black-eyed beans, garbanzo beans, cranberry beans, white beans, rice beans, butter beans, Adzuki beans, black-eyed peas, cowpeas, cannelini beans, chickpeas, fava beans, broad beans, Flageolet beans, mung beans, Soissons beans, soybeans, and combinations of any thereof.

32. A food composition comprising:
a potato product; and
an edible bean product; wherein the edible bean product comprises a dehydrated legume product.

33. The food composition of claim 32, wherein the dehydrated legume product is selected from the group consisting of legume flakes, legume powder, whole legumes, legume pieces, and combinations of any thereof.

34. The food composition of claim 32, wherein the potato product is selected from the group consisting of French fries, tater tots, hash browns, and potato formed patties.
